(19) United States
(12) Patent Application Publication
(10) Pub. No.: US 2025/0073626 A1
(43) Pub. Date: Mar. 6, 2025

(54) SILICA CERAMIC MATERIAL, CERAMIC FOAM FILTER, AND PREPARATION METHOD AND USE OF CERAMIC FOAM FILTER

(71) Applicant: BAODING NINGXIN GROUP CO., LTD, Baoding (CN)

(72) Inventors: Dengning CHEN, Baoding (CN); Shujing WANG, Baoding (CN)

(21) Appl. No.: 18/579,551

(22) PCT Filed: Aug. 17, 2023
(86) PCT No.: PCT/CN2023/113466

§ 371 Date: Jan. 16, 2024

(30) Foreign Application Priority Data
May 10, 2023 (CN) 202310517405.1

(51) Int. Cl. B01D 39/20; B22D 43/00; B28B 19/00; C04B 35/14; C04B 35/626; C04B 35/63; C04B 35/634; C04B 35/64; C04B 38/00; C04B 38/06

(52) U.S. Cl. CPC B01D 39/2093; B22D 43/004; C04B 35/14; C04B 35/62625; C04B 35/62655; C04B 35/62675; C04B 35/6316; C04B 35/63416; C04B 35/64; C04B 38/0051; C04B 38/0615; B01D 2239/10; B01D 2239/1208; B28B 19/00; C04B 2235/3217; C04B 2235/3418; C04B 2235/3826; C04B 2235/606; C04B 2235/6562; C04B 2235/6567

(57) ABSTRACT

Provided are a silica ceramic material, a ceramic foam filter, and a preparation method and use of the ceramic foam filter. The silica ceramic material includes a ceramic powder and an auxiliary material, where the ceramic powder includes the following components by mass percentage: 40% to 80% of silica, 8% to 30% of alumina, and 8% to 30% of silicon carbide; and the auxiliary material includes a binder and a dispersing agent: a mass of the binder accounts for 1% to 5% of a mass of the ceramic powder, and a mass of the dispersing agent accounts for 0.5% to 1% of the mass of the ceramic powder.

### CROSS REFERENCE TO RELATED APPLICATION

The application claims the priority and benefit of Chinese Patent Application No. CN2023105174051, entitled “SILICA CERAMIC MATERIAL, CERAMIC FOAM FILTER, AND PREPARATION METHOD AND USE OF CERAMIC FOAM FILTER” filed with the China National Intellectual Property Administration (CNIPA) on May 10, 2023, the disclosure of which is incorporated herein by reference in its entirety as part of the application.

### TECHNICAL FIELD

The present disclosure relates to the technical field of casting, and in particular to a silica ceramic material, a ceramic foam filter, and a preparation method and use of the ceramic foam filter.

### BACKGROUND

With the rapid development of the casting industry, the requirements on performance and appearance of castings are increasingly high. Non-metallic inclusions in castings are the most important factor causing defects in castings, which affect surface roughness, mechanical and processing properties of castings and lead to an increase in scrap rate. Therefore, inclusions in a molten metal need to be filtered out before filling.

Currently, in the casting industry, molten metals for producing iron castings and steel castings are generally filtered by a ceramic foam filter. The ceramic foam filter has a three-dimensional (3D) network skeleton structure, which could effectively remove inclusions in molten metals and reduce turbulence to make molten metals reach the filling flow rate quickly and stably, thereby improving the quality of castings. Ceramic foam filters commonly used at present are silicon carbide ceramic foam filters or zirconia ceramic foam filters. Silicon carbide ceramic foam filters or zirconia ceramic foam filters are mainly made of silicon carbide powder or zirconia powder, and both of them have high cost, where the cost of zirconia ceramic foam filters is higher (about 5 times that of silicon carbide ceramic foam filters). Ceramic foam filters are disposable consumables, which brings great economic pressure to users. Moreover, the maximum working temperature of silicon carbide ceramic foam filters is 1,500° C., and the maximum working temperature of zirconia ceramic foam filters is 1,700° C.; as a result, for some molten metals with a temperature of 1,500° C. to 1,600° C., only zirconia ceramic foam filters could be used for filtration. Currently, there is no ceramic foam filter with a maximum working temperature of 1,600° C. and a low cost in the art.

### SUMMARY

In view of this, the present disclosure provides a silica ceramic material, a ceramic foam filter, and a preparation method and use of the ceramic foam filter. The silica ceramic material according to the present disclosure includes silica as a main component. A silica ceramic foam filter prepared from the silica ceramic material has low cost and a maximum working temperature of 1,600° C., and is suitable for filtration of a molten metal with a temperature of 1,600° C. or lower.

To achieve the object, the present disclosure provides the following technical solutions.

The present disclosure provides a silica ceramic material, including a ceramic powder and an auxiliary material,
where the ceramic powder includes the following components by mass percentage: 40% to 80% of silica, 8% to 30% of alumina, and 8% to 30% of silicon carbide;
the auxiliary material includes a binder and a dispersing agent; a mass of the binder accounts for 1% to 5% of a mass of the ceramic powder; and a mass of the dispersing agent accounts for 0.5% to 1% of the mass of the ceramic powder.

In some embodiments, the alumina is α-alumina, and the alumina has a mesh number of not less than 200 mesh and a purity of not lower than 98%;
the silica has a mesh number of not less than 1,000 mesh and a purity of not lower than 95%; and
the silicon carbide has a mesh number of not less than 200 mesh and a purity of not lower than 95%.

In some embodiments, the binder includes one or more selected from the group consisting of silica sol, methyl cellulose (MC), white latex, sodium carboxymethyl cellulose (Na-CMC), polyvinyl alcohol (PVA), polyvinyl butyral (PVB), phenolic resin, and ethyl silicate; and the dispersing agent is at least one selected from the group consisting of sodium hexametaphosphate (SHMP) and sodium tripolyphosphate (STPP).

In some embodiments, the silica sol has a concentration of 30 wt % to 50 wt %.

The present disclosure also provides a silica ceramic foam filter prepared from the silica ceramic material as described in the above solutions.

In some embodiments, a crystal phase of silica in the silica ceramic foam filter is one or more selected from the group consisting of β-quartz, α-quartz, γ-tridymite, β-tridymite, α-tridymite, β-cristobalite, α-cristobalite, and quartz glass.

In some embodiments, an apparent porosity of the silica ceramic foam filter is in a range of 80% to 83%.

The present disclosure also provides a method for preparing the silica ceramic foam filter as described in the above solutions, including the following steps:
mixing the ceramic powder, the auxiliary material, and water to obtain a ceramic slurry;
immersing a foam matrix in the ceramic slurry, and removing an excess slurry adsorbed in the foam matrix to obtain an immersed foam body; and
drying and sintering the immersed foam body successively to obtain the silica ceramic foam filter.

In some embodiments, an amount of the water accounts for 15% to 25% of the mass of the ceramic powder.

In some embodiments, the ceramic slurry has a viscosity of 20,000 MPa·s to 50,000 MPa·s.

In some embodiments, the foam matrix is a porous polyurethane (PU) foam.

In some embodiments, the porous PU foam has a pore number of 10 PPI to 20 PPI and a size of (75-100) mm×(75-100) mm×22 mm.

In some embodiments, the drying in conducted by oven-drying or natural drying; the oven-drying is conducted at a temperature of 100° C. to 120° C. for 60 min to 90 min; and the natural drying is conducted for 6 h to 12 h.

In some embodiments, the sintering is conducted at a temperature of 1,150° C. to 1,300° C. for 2 h to 4 h; and

a procedure for raising to the temperature for the sintering is as follows: raising to a first temperature at a first heating rate, raising to a second temperature at a second heating rate, and raising to the temperature for the sintering at a third heating rate, where the first heating rate is in a range of 70° C./h to 90° C./h and the first temperature is in a range of 500° C. to 550° C.; the second heating rate is in a range of 200° C./h to 250° C./h and the second temperature is in a range of 1,000° C. to 1,100° C.; and the third heating rate is in a range of 70° C./h to 90° C./h.

The present disclosure also provides a use of the silica ceramic foam filter as described in the above solutions or the silica ceramic foam filter prepared by the method as described in the above solutions in casting.

In some embodiments, a working temperature of the silica ceramic foam filter is not more than 1,600° C.

The present disclosure provides a silica ceramic material, including a ceramic powder and an auxiliary material, where the ceramic powder includes the following components by mass percentage: 40% to 80% of silica, 8% to 30% of alumina, and 8% to 30% of silicon carbide; the auxiliary material includes a binder and a dispersing agent; a mass of the binder accounts for 1% to 5% of a mass of the ceramic powder; a mass of the dispersing agent accounts for 0.5% to 1% of the mass of the ceramic powder. The silica ceramic material according to the present disclosure includes silica as a main component, and silica is widely available and has a low cost and excellent high-temperature resistance.

The present disclosure also provides a silica ceramic foam filter prepared from the silica ceramic material as described in the above solutions. The silica ceramic foam filter according to the present disclosure includes silica as a main component, and silica is widely available and has low cost, where a price of silica is only about 50% of that of a silicon carbide powder. Therefore, the ceramic foam filter has significantly reduced cost compared with costs of the silicon carbide and zirconia ceramic foam filters common in the art. Moreover, the silica ceramic foam filter according to the present disclosure has excellent heat resistance and a maximum working temperature of 1,600° C., thereby filling the blank that the ceramic foam filters could work in a temperature range of 1,500° C. to 1,600° C. In addition, the silica ceramic foam filter according to the present disclosure has excellent filtration performance, and could effectively filter inclusions in a molten metal out.

### BRIEF DESCRIPTION OF THE DRAWINGS

FIG. 1 is a flow chart showing a method for preparing a silica ceramic foam filter according to an embodiment of the present disclosure.

### DETAILED DESCRIPTION OF THE EMBODIMENTS

The present disclosure provides a silica ceramic material, including a ceramic powder and an auxiliary material,
where the ceramic powder includes the following components by mass percentage: 40% to 80% of silica, 8% to 30% of alumina, and 8% to 30% of silicon carbide;
the auxiliary material includes a binder and a dispersing agent; a mass of the binder accounts for 1% to 5% of a mass of the ceramic powder; and a mass of the dispersing agent accounts for 0.5% to 1% of the mass of the ceramic powder.

Unless otherwise specified, each raw material used herein is a commercially-available product.

The silica ceramic material according to the present disclosure includes a ceramic powder and an auxiliary material, which is described in detail below.

In some embodiments, by mass percentage, the ceramic powder includes 40% to 80%, preferably 40% to 75% of silica. In some embodiments, the silica has a mesh number of not less than 200 mesh (that is, the silica has a particle size of not more than 74 μm) and a purity of not lower than 95%. There are no special requirements on the silica, and a silica powder well-known in the art may be used. In the present disclosure, the silica mainly plays a skeleton role, which is conducive to improving the impact resistance of a ceramic foam filter at a high temperature. Silica is often added as a sintering aid at a very small amount to a silicon carbide ceramic foam filter, which is intended to reduce a sintering temperature and improve a sintering effect. In the present disclosure, silica is used as a main raw material to prepare a silica ceramic material. A ceramic foam filter prepared from the ceramic material according to the present disclosure not only has excellent filtration performance and heat resistance, but also has a greatly-reduced cost.

In some embodiments, by a mass percentage, the ceramic powder includes 8% to 30% and preferably 10% to 25% of alumina. In some embodiments, the alumina is α-alumina, and the alumina has a mesh number of not less than 1,000 mesh (that is, the alumina has a particle size of not more than 13 μm) and a purity of not lower than 98%. The alumina plays a matrix role, which is conducive to improving the sintering strength of ceramic foam filters and reducing the firing temperature of products.

In some embodiments, by a mass percentage, the ceramic powder includes 8% to 30% of silicon carbide, preferably 10% to 20%, and more preferably 10% to 15%. In some embodiments, the silicon carbide has a mesh number of not less than 1,000 mesh (that is, the silicon carbide has a particle size of not more than 13 μm) and a purity of not lower than 95%. The silicon carbide could improve a coefficient of thermal conductivity (CTC) and reduce a coefficient of expansion (COE) for ceramic foam filters, thereby improving the thermal stability of products.

In some embodiments, the auxiliary material includes a binder and a dispersing agent; a mass of the binder accounts for 1% to 5% and preferably 2% to 4% of a mass of the ceramic powder; and a mass of the dispersing agent accounts for 0.5% to 1% and preferably 0.6% to 0.8% of the mass of the ceramic powder.

In some embodiments, the binder includes one or more selected from the group consisting of silica sol, MC, white latex, Na-CMC, PVA, PVB, phenolic resin, and ethyl silicate, where a concentration of the silica sol is 30 wt % to 50 wt % and preferably 40 wt %; and the dispersing agent includes at least one selected from the group consisting of SHMP and STPP.

The present disclosure also provides a silica ceramic foam filter prepared from the silica ceramic material as described in the above solutions. In some embodiments, a crystal phase of silica in the silica ceramic foam filter is one or more selected from the group consisting of β-quartz, α-quartz, γ-tridymite, β-tridymite, α-tridymite, β-cristobalite, α-cristobalite, and quartz glass. In the present disclosure, proportions of the ceramic powder and the auxiliary material in the silica ceramic material are strictly controlled, such that a ceramic foam filter with excellent filtration performance and heat resistance could be prepared under the conditions that silica is used as a main material, meeting the requirements for filtration of molten metals. In some embodiments, the silica ceramic foam filter has a total porosity of 78% to 85% and an apparent porosity of 80% to 83%.

The present disclosure also provides a method for preparing the silica ceramic foam filter as described in the above solutions, including the following steps:
mixing the ceramic powder, the auxiliary material, and water to obtain a ceramic slurry;
immersing a foam matrix in the ceramic slurry, and then removing an excess slurry adsorbed in the foam matrix to obtain an immersed foam body; and
drying and sintering the immersed foam body successively to obtain the silica ceramic foam filter.

The ceramic powder, the auxiliary material, and water are mixed to obtain a ceramic slurry. In some embodiments, an amount of the water accounts for 15% to 25% of the mass of the ceramic powder, preferably 18% to 22%. In some embodiments, the mixing is conducted by a high-speed mixer. In some embodiments, the ceramic slurry has a viscosity of 20,000 MPa·s to 50,000 MPa·s, and preferably 20,000 MPa·s to 30,000 MPa·s or 40,000 Mpa·s to 50,000 Mpa·s.

After the ceramic slurry is obtained, a foam matrix is immersed in the ceramic slurry, and an excess slurry adsorbed in the foam matrix is removed to obtain an immersed foam body. In some embodiments, the foam matrix is a porous PU foam, and the porous PU foam has a pore number of 10 PPI to 20 PPI. In some embodiments, the porous PU foam has a size of preferably (75-100) mm×(75-100) mm×22 mm. In a specific embodiment, before the immersing, the method as described in the above solutions further includes slicing and then die-cutting and molding the porous PU foam to obtain a porous PU foam meeting size requirement. In some embodiments, the immersing is conducted at room temperature for 1 min to 3 min. There are no special requirements for specific operation conditions of the immersing, as long as the porous PU foam is placed in the ceramic slurry and fully impregnated with the slurry. In some embodiments, an excess slurry adsorbed in the foam matrix is removed by squeezing. In some embodiments, the squeezing is conducted by a roller press with a gap of 2 mm to 10 mm. In the present disclosure, by controlling the gap of the roller press, about 60% of the slurry absorbed into the foam matrix is squeezed out to obtain the immersed foam body.

After the immersed foam body is obtained, it is dried and sintered successively to obtain the silica ceramic foam filter. In some embodiments, the drying is conducted by oven-drying or natural drying. In some embodiments, the oven-drying is conducted at a temperature of 100° C. to 120° C. and preferably 105° C. to 110° C. In some embodiments, the oven-drying is conducted for 60 min to 90 min and preferably 60 min to 70 min. In some embodiments, the natural drying is conducted for 6 h to 12 h and preferably 8 h to 10 h.

In some embodiments, the sintering is conducted at a temperature of 1,150° C. to 1,300° C. and preferably 1,200° C. to 1,250° C. In some embodiments, the sintering is conducted for 2 h to 4 h and preferably 2.5 h to 3.5 h. In some embodiments, a procedure for raising to the temperature for the sintering is as follows: raising to a first temperature at a first heating rate, raising to a second temperature at a second heating rate, and raising to the temperature for the sintering at a third heating rate, where the first heating rate is in a range of 70° C./h to 90° C./h and preferably 75° C./h to 85° C./h, and the first temperature is in a range of 500° C. to 550° C. and 500° C. to 520° C.; the second heating rate is in a range of 200° C./h to 250° C./h and preferably 230° C./h to 250° C./h, and the second temperature is in a range of 1,000° C. to 1,100° C. and preferably 1,000° C. to 1,050° C.; and the third heating rate is in a range of 70° C./h to 90° C./h and preferably 75° C./h to 85° C./h. In some embodiments, raising to the temperature for the sintering is conducted in accordance with the above procedure, which is conducive to uniform heating of the immersed foam body and improvement of sintering effects. During the sintering, the foam matrix is decomposed under heat to leave a foam-like ceramic product, namely, the silica ceramic foam filter according to the present disclosure; and after the sintering is completed, a product could be cooled with furnace temperature to 100° C. and then taken out.

The present disclosure also provides use of the silica ceramic foam filter as described in the above solutions or a silica ceramic foam filter prepared by the method as described in the above solutions in casting. The silica ceramic foam filter according to the present disclosure could be used for filtration of a molten metal during casting; and has a working temperature of not more than 1,600° C. and preferably between 1,500° C. and 1,600° C.

The technical solutions of the present disclosure will be clearly and completely described below in conjunction with the examples of the present disclosure. Obviously, such examples are merely some rather than all of the embodiments of the present disclosure. All other embodiments obtained by a person of ordinary skill in the art based on the embodiments of the present disclosure without creative efforts shall fall within the scope of the present disclosure.

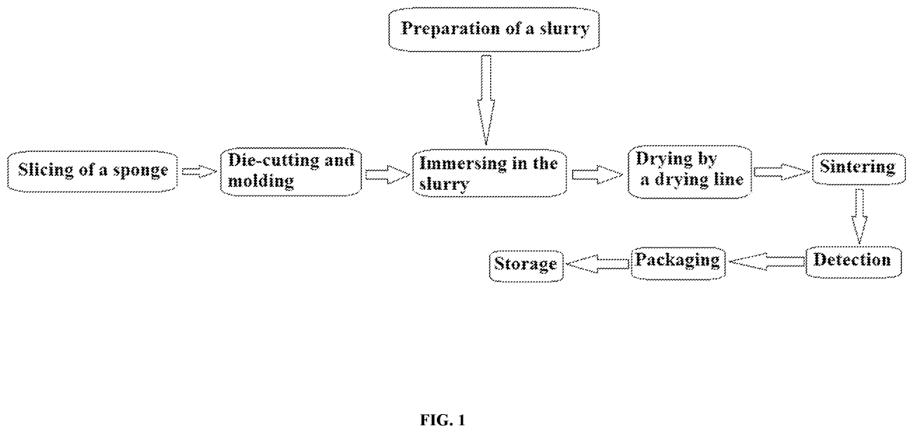

FIG. 1 is a flow chart showing the method for preparing the silica ceramic foam filter according to the embodiment of the present disclosure, where a porous PU foam (namely, a PU sponge) is subjected to slicing and then die-cutting and molding, then immersed in a ceramic slurry, and then dried and sintered, and a resulting product is packaged and stored after being tested to be qualified.

### Example 1

40 kg of commercially-available silica with a purity of 95% and a mesh number of 200 mesh, 30 kg of α-alumina with a purity of 98% and a mesh number of 1,000 mesh, 30 kg of silicon carbide with a purity of 95% and a mesh number of 1,000 mesh, and 15 kg of pure water were mixed. 5 kg of silica sol (with a concentration of 40 wt %) and 1.0 kg of SHMP were added thereto, and a resulting mixture was stirred to be uniform by a high-speed mixer to obtain a thixotropic slurry with a viscosity of 40,000 MPa·s, as a ceramic slurry. A PU foam with a specification of 10 PPI-100 mm×100 mm×22 mm was immersed in the ceramic slurry and fully impregnated with the slurry, and then about 60% of the slurry adsorbed was squeezed out by a roller press to obtain an immersed foam body. The immersed foam body was dried at 110° C. for 1 h and then introduced into a sintering furnace; after that, the immersed foam body was heated to 500° C. at a heating rate of 90° C./h, then heated to 1,000° C. at a heating rate of 250° C./h, then heated to 1,150° C. at a heating rate of 90° C./h, and held at 1,150° C. for 2 h, and then cooled with furnace temperature to about 100° C. and taken out from the sintering furnace to obtain a silica ceramic foam filter with a specification of 100 mm×100 mm×22 mm-10 PPI. It was tested that an apparent porosity of the silica ceramic foam filter is 82%.

The silica ceramic foam filter prepared in Example 1 was used to filter a molten steel with a temperature of 1,527° C., and inclusions in the molten steel could be effectively filtered out, with a filtration efficiency of 95%. The silica ceramic foam filter was not destroyed after filtering 800 kg of the molten steel, that is, after 800 kg of the molten steel was filtered by the silica ceramic foam filter prepared in Example 1, the filter could still remain intact, indicating that the filter has an excellent impact resistance.

An ordinary silicon carbide ceramic foam filter was used to filter a molten steel with a temperature of 1,527° C., and after filtering 500 kg of the molten steel the silicon carbide ceramic foam filter has been destroyed, indicating that the ordinary silicon carbide ceramic foam filter is difficult to allow filtration of a molten metal at 1,500° C. or more. The silica ceramic foam filter according to the present disclosure has a low cost, exhibits excellent high-temperature resistance and impact resistance, and is suitable for filtration of a molten metal at a temperature between 1,500° C. and 1,600° C.

### Example 2

75 kg of commercially-available silica with a purity of 98% and a mesh number of 325 mesh, 10 kg of α-alumina with a purity of 99% and a mesh number of 2,000 mesh, 15 kg of silicon carbide with a purity of 96% and a mesh number of 3,000 mesh, and 18 kg of pure water were mixed. 3 kg of PVA and 0.5 kg of STPP were added thereto, and a resulting mixture was stirred to be uniform by a high-speed mixer to obtain a thixotropic slurry with a viscosity of 30,000 MPa·s, as a ceramic slurry. A PU foam with a specification of 20 PPI-75 mm×75 mm×22 mm was immersed in the ceramic slurry and fully impregnated with the slurry, and then about 60% of the slurry adsorbed was squeezed out by a roller press to obtain an immersed foam body. The immersed foam body was naturally dried for 12 h and then introduced into a sintering furnace; after that, the immersed foam body was heated to 500° C. at a heating rate of 90° C./h, then heated to 1,000° C. at a heating rate of 250° C./h, then heated to 1,250° C. at a heating rate of 90° C./h, and held at 1,250° C. for 2 h, and then cooled with furnace temperature to 100° C. and taken out from the sintering furnace to obtain a silica ceramic foam filter with a specification of 75 mm×75 mm×22 mm-20 PPI. It was tested that an apparent porosity of the silica ceramic foam filter is 81%.

The silica ceramic foam filter prepared in Example 2 was used to filter a molten steel with a temperature of 1,600° C., and inclusions in the molten steel could be effectively filtered out, with a filtration efficiency of 96%. The silica ceramic foam filter was not destroyed after filtering 500 kg of the molten steel.

The above are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

1. A silica ceramic material, comprising:
a ceramic powder; and
an auxiliary material,
wherein the ceramic powder comprises the following components by mass percentage: 40% to 80% of silica, 8% to 30% of alumina, and 8% to 30% of silicon carbide;
wherein the auxiliary material comprises a binder and a dispersing agent; a mass of the binder accounts for 1% to 5% of a mass of the ceramic powder; and a mass of the dispersing agent accounts for 0.5% to 1% of the mass of the ceramic powder.

2. The silica ceramic material of claim 1, wherein the alumina is α-alumina, and the alumina has a mesh number of not less than 200 mesh and a purity of not lower than 98%;
the silica has a mesh number of not less than 1,000 mesh and a purity of not lower than 95%; and
the silicon carbide has a mesh number of not less than 200 mesh and a purity of not lower than 95%.

3. The silica ceramic material of claim 1, wherein the binder comprises one or more selected from the group consisting of silica sol, methyl cellulose (MC), white latex, sodium carboxymethyl cellulose (Na-CMC), polyvinyl alcohol (PVA), polyvinyl butyral (PVB), phenolic resin, and ethyl silicate; and
the dispersing agent comprises at least one selected from the group consisting of sodium hexametaphosphate (SHMP) and sodium tripolyphosphate (STPP).

4. The silica ceramic material of claim 3, wherein the silica sol has a concentration of 30 wt % to 50 wt %.

5. A silica ceramic foam filter prepared from the silica ceramic material of claim 1.

6. The silica ceramic foam filter of claim 5, wherein a crystal phase of silica in the silica ceramic foam filter is one or more selected from the group consisting of β-quartz, α-quartz, γ-tridymite, β-tridymite, α-tridymite, β-cristobalite, α-cristobalite, and quartz glass.

7. The silica ceramic foam filter of claim 5, wherein an apparent porosity of the silica ceramic foam filter is in a range of 80% to 83%.

8. A method for preparing the silica ceramic foam filter of claim 5, the method comprising:
mixing the ceramic powder, the auxiliary material, and water to obtain a ceramic slurry;
immersing a foam matrix in the ceramic slurry, and removing an excess slurry adsorbed in the foam matrix to obtain an immersed foam body; and
drying and sintering the immersed foam body successively to obtain the silica ceramic foam filter.

9. The method of claim 8, wherein an amount of the water accounts for 15% to 25% of the mass of the ceramic powder.

10. The method of claim 8, wherein the ceramic slurry has a viscosity of 20,000 MPa·s to 50,000 MPa·s.

11. The method of claim 8, wherein the foam matrix is a porous polyurethane (PU) foam.

12. The method of claim 8, wherein the porous PU foam has a pore number of 10 PPI to 20 PPI and a size of (75-100) mm×(75-100) mm×22 mm.

13. The method of claim 8, wherein the drying is conducted by oven-drying or natural drying; the oven-drying is conducted at a temperature of 100° C. to 120° C. for 60 min to 90 min; and the natural drying is conducted for 6 h to 12 h.

14. The method of claim 8, wherein the sintering is conducted at a temperature of 1,150° C. to 1,300° C. for 2 h to 4 h; and
a procedure for raising to the temperature for the sintering is as follows: raising to a first temperature at a first heating rate, raising to a second temperature at a second heating rate, and raising to the temperature for the sintering at a third heating rate, wherein the first heating rate is in a range of 70° C./h to 90° C./h and the first temperature is in a range of 500° C. to 550° C.; the second heating rate is in a range of 200° C./h to 250° C./h and the second temperature is in a range of 1,000° C. to 1,100° C.; and the third heating rate is in a range of 70° C./h to 90° C./h.

15. A method of using the silica ceramic foam filter of claim 5, comprising using the silica ceramic foam filter in casting.

16. The method of claim 15, wherein a working temperature of the silica ceramic foam filter is not more than 1,600° C.

17. The silica ceramic foam filter of claim 5, wherein the alumina is α-alumina, and the alumina has a mesh number of not less than 200 mesh and a purity of not lower than 98%;
the silica has a mesh number of not less than 1,000 mesh and a purity of not lower than 95%; and
the silicon carbide has a mesh number of not less than 200 mesh and a purity of not lower than 95%.

18. The silica ceramic foam filter of claim 5, wherein the binder comprises one or more selected from the group consisting of silica sol, methyl cellulose (MC), white latex, sodium carboxymethyl cellulose (Na-CMC), polyvinyl alcohol (PVA), polyvinyl butyral (PVB), phenolic resin, and ethyl silicate; and
the dispersing agent comprises at least one selected from the group consisting of sodium hexametaphosphate (SHMP) and sodium tripolyphosphate (STPP).

19. The method of claim 8, wherein a crystal phase of silica in the silica ceramic foam filter is one or more selected from the group consisting of β-quartz, α-quartz, γ-tridymite, β-tridymite, α-tridymite, β-cristobalite, α-cristobalite, and quartz glass.

20. The method of claim 8, wherein an apparent porosity of the silica ceramic foam filter is in a range of 80% to 83%.
